(19) United States
(12) Patent Application Publication
(10) Pub. No.: US 2009/0030715 A1
(43) Pub. Date: Jan. 29, 2009

(54) Travel Timer

(75) Inventors: Calsee N. Robb, Seattle, WA (US); Domenic S. Giuntoli, Seattle, WA (US); Heidi J. Kneller, Bellevue, WA (US); Richard K. Simms, Mukilteo, WA (US)

Correspondence Address: LEE & HAYES, PLLC, 601 W. RIVERSIDE AVE., SUITE 1400, SPOKANE, WA, 99201, US

(73) Assignee: THE BOEING COMPANY, Chicago, IL (US)

(21) Appl. No.: 12/042,298

(22) Filed: Mar. 4, 2008

Related U.S. Application Data
(60) Provisional application No. 60/951,434, filed on Jul. 23, 2007.

(51) Int. Cl. G06Q 99/00; G01C 21/34

(52) U.S. Cl. 705/1; 701/209; 701/210

(57) ABSTRACT

Systems and methods are described for improved schedule keeping for travelers. In one embodiment, a method including includes providing one or more travel milestones; providing travel plan information; formulating a travel plan based on the one or more travel milestones and the travel plan information; receiving one or more travel-related inputs; analyzing the one or more travel-related inputs to determine a travel status based on the one or more travel-related inputs and the travel plan; and outputting the travel status to the

### CROSS REFERENCE TO RELATED APPLICATIONS

This patent application claims priority under 35 U.S.C. §119(e) from U.S. Provisional Application No. 60/951,434 filed Jul. 23, 2007, which provisional application is incorporated herein by reference.

### FIELD OF THE INVENTION

The field of the present disclosure relates to schedule keeping, and more specifically, to systems and methods that provide information to a traveler during a trip, such as whether they are ahead of schedule, on schedule, or behind schedule.

### BACKGROUND

Travelers typically prefer to stay on schedule. Travel delays may result in undesirable consequences, such as missed connections, delayed meetings, increased costs, and missed business opportunities. Thus, travelers may frequently examine their current travel status and project ahead to attempt to estimate whether they are on schedule, and if not, whether anything can be done to correct the situation.

There are many different sources of information available to a traveler to help the traveler examine their current travel status, including aircraft flight schedules, bus and subway schedules, ship and ferry schedules, traffic flow maps, weather information, accident reports, wait times published by the Transportation Security Administration, and a variety of other suitable information sources. Although desirable results have been achieved using such prior art sources of information, there is room for improvement. For example, some of the prior art sources of information may not be capable of providing real-time information to the traveler. Others may require an undesirable amount of labor and time to access the desired information, and still others may not be readily accessible to the traveler. There is no system that aggregates all of the data into one system for the traveler. Therefore, improved schedule-keeping systems and methods that mitigate these undesirable characteristics would have utility.

### SUMMARY

The present disclosure is directed to systems and methods for schedule keeping that provide information to a traveler. Embodiments of systems and methods in accordance with the present disclosure may advantageously assist a traveler in keeping with an established or desired travel schedule, and may make the travel process, and all of the sub-processes involved in the travel process, easier for the traveler to navigate.

In one embodiment, a method of providing a travel schedule for a traveler includes providing one or more travel milestones; providing travel plan information; formulating a travel plan based on the one or more travel milestones and the travel plan information; receiving one or more travel-related inputs; analyzing the one or more travel-related inputs to determine a travel status based on the one or more travel-related inputs and the travel plan; and outputting the travel status to the traveler.

In another embodiment, a method of providing a travel schedule for a traveler includes providing a plurality of travel milestones and travel plan information; formulating a travel plan based on the plurality of travel milestones and travel plan information; receiving a plurality of travel-related inputs; analyzing the plurality of travel-related inputs to determine a travel status based on the plurality of travel-related inputs and the travel plan; if the travel status comprises a behind-schedule status, formulating a revised travel plan based on the plurality of travel-related inputs and the plurality of travel milestones and travel plan information; and outputting to the traveler a proposed remedial action in accordance with the revised travel plan.

In yet another embodiment, a schedule-keeping device includes a processor; at least one input/output component coupled to the processor and configured to communicate with one or more sources of information via a network, and to provide output to the traveler; a memory operatively coupled to the processor and to the at least one input/output component, the memory being configured to store instructions that, when executed by the processor, perform a method including: receiving a plurality of travel milestones and travel plan information; providing travel plan information; formulating a travel plan based on the one or more travel milestones and the travel plan information; receiving one or more travel-related inputs; analyzing the one or more travel-related inputs to determine a travel status based on the one or more travel-related inputs and the travel plan; and outputting the travel status to the traveler.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

Embodiments of systems and methods in accordance with the teachings of the present disclosure are described in detail below with reference to the following drawings.

FIG. 1 is an exemplary environment for implementing systems and methods for schedule-keeping in accordance with the present disclosure;

FIG. 2 is a schematic view of a schedule-keeping device in accordance with an embodiment of the present disclosure; and

FIG. 3 is a flowchart of a method of schedule keeping in accordance with another embodiment of the present disclosure.

### DETAILED DESCRIPTION

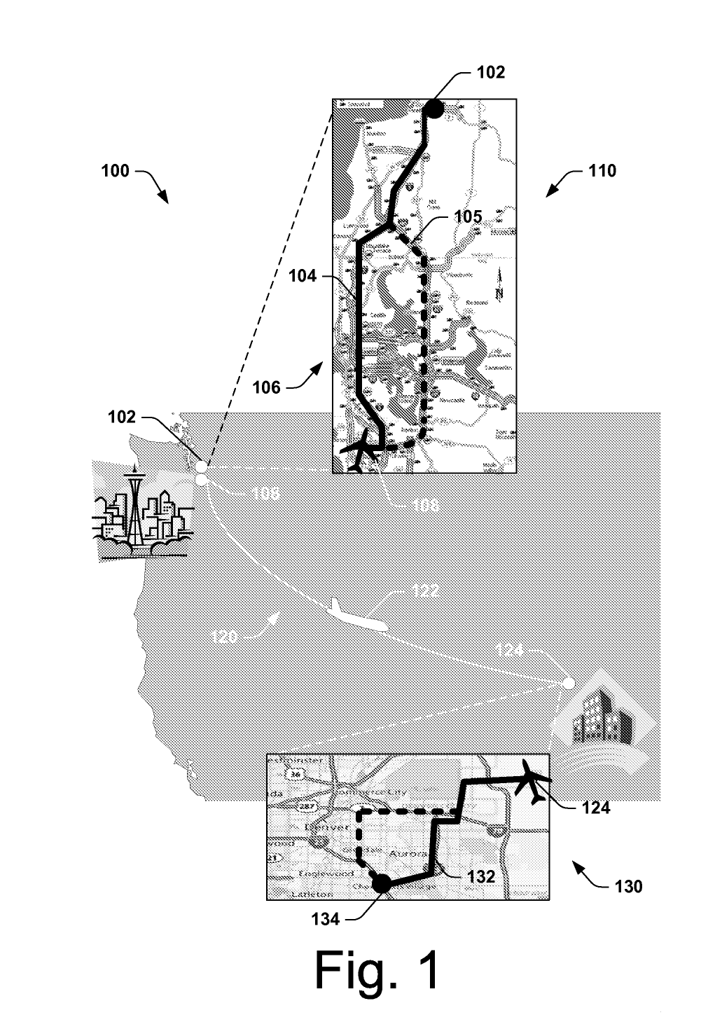

The present disclosure teaches systems and methods for schedule keeping that provide information to a traveler. Many specific details of certain embodiments of the invention are set forth in the following description and in FIGS. 1-3 to provide a thorough understanding of such embodiments. One skilled in the art, however, will understand that the invention may have additional embodiments, or that the invention may be practiced without several of the details described in the following description.

Generally, embodiments of systems and methods in accordance with the present disclosure integrate a vast array of travel resources from the internet and other sources, and are configured to pull all of the necessary information together, store the information, and combine the information into a logical format that develops and provides an accurate and constantly up-to-date schedule to the traveler. In some embodiments, a system includes a portable electronic device that may be carried by a traveler, or integrated into another device that the traveler may be carrying that informs the traveler at a glance of their schedule status, including if they are ahead of, behind, or on schedule when traveling, and may also provide more detailed information when requested. In further embodiments, if delays or interruptions are expected, the system may access the information sources automatically and begin finding a solution to the problem to suggest to the traveler before the traveler has to start thinking about the next steps.

FIG. 1 is an exemplary environment 100 for implementing systems and methods for schedule-keeping in accordance with the present disclosure. In this embodiment, a traveler desires to travel from an office 102 in Everett, Wash., and end at a hotel 134 in Denver, Colo. More specifically, in a first portion (or leg) 110, the traveler plans to leave the office 102 and travel by automobile along a first highway 104 (e.g. Interstate 5) through Seattle 106 en route to SeaTac Airport (SEA) 108. In a second portion 120, the traveler intends to fly on a commercial aircraft 122 from SeaTac Airport 108 to Denver International Airport (DIA) 124. And in a third portion 130, the traveler intends to take a pubic transportation bus along a first bus route 132 from the DIA airport 124 to the hotel 134.

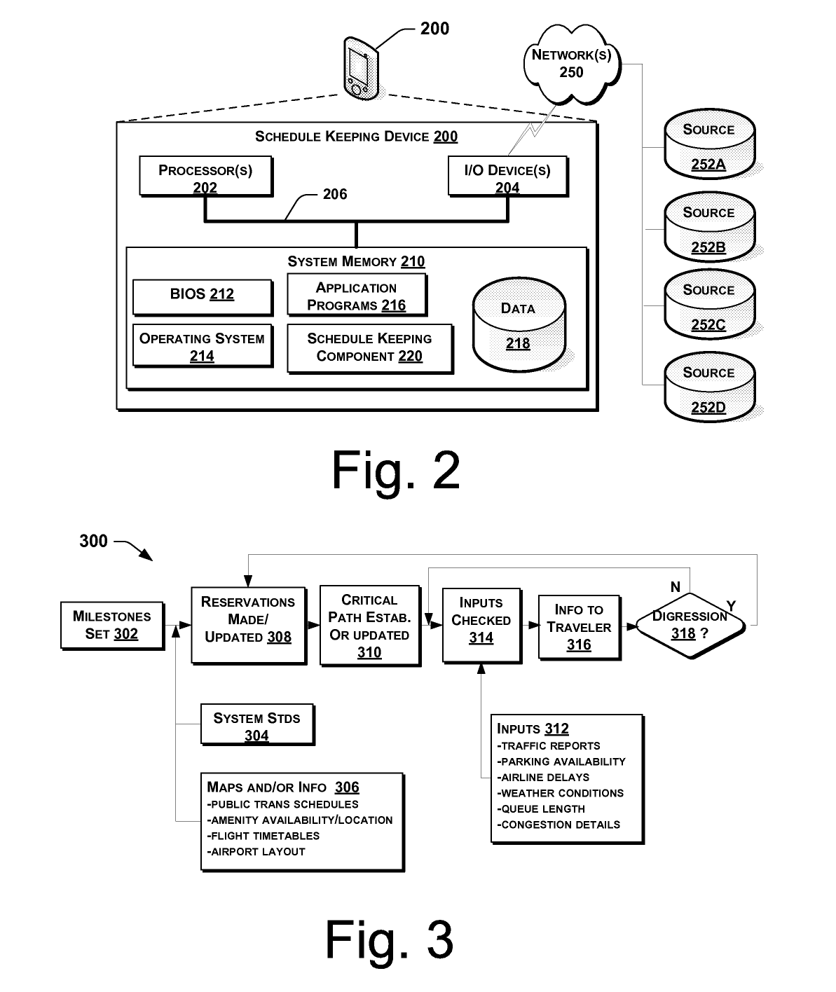

FIG. 2 is a schematic view of an embodiment of a schedule-keeping device 200 that may be carried by the traveler in the environment 100. In this embodiment, the device 200 includes one or more processors 202 and one or more input/output (I/O) components 204 (e.g., keyboard, mouse, transmitter, receiver, etc.) coupled to a system memory 210 by a bus 206. The system bus 206 represents any of the several types of bus structures, including a memory bus or memory controller, a peripheral bus, an accelerated graphics port, and a processor or local bus using any of a variety of bus architectures. The I/)O component 204 is configured to operatively communicate with one or more external networks 250, such as a cellular telephone network, a satellite network, an information network (e.g. Internet, intranet, LAN, WAN, etc.), or any other suitable network. As shown in FIG. 2, the schedule-keeping device 200 accesses a plurality of information sources 252 via the network 250.

A schedule-keeping component 220 is stored in the system memory 210 and executable on the processor 202. The schedule-keeping component 220 may receive information from the various information sources 252, and is configured to perform one or more of the techniques for schedule keeping in accordance with the teachings of the present disclosure, as described more fully below.

With continued reference to FIG. 2, the system memory 210 may include computer-readable media configured to store data and/or program modules for implementing the techniques disclosed herein that are immediately accessible to and/or presently operated on by the processor 202. For example, in addition to the schedule-keeping component 220, the system memory 210 also stores a basic input/output system (BIOS) 212, an operating system 214, one or more application programs 216, and program data 218 that can be accessed by the processor 202 during execution of the schedule keeping component 220.

The computer-readable media included in the system memory 210 can be any available media that can be accessed by the device 200, including computer storage media and communication media. Computer storage media include both volatile and nonvolatile, removable and non-removable media implemented in any method or technology for storage of information such as computer-readable instructions, data structures, program modules, or other data. Computer storage media includes, but is not limited to, and random access memory (RAM), read only memory (ROM), electrically erasable programmable ROM (EEPROM), flash memory or other memory technology, compact disk ROM (CD-ROM), digital versatile disks (DVD) or other optical disk storage, magnetic cassettes, magnetic tape, magnetic disk storage or other magnetic storage devices, or any other medium, including paper, punch cards and the like, which can be used to store the desired information and which can be accessed by computer 200.

Similarly, communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

Generally, program modules executed on the device 200 (FIG. 2) may include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

The schedule-keeping device 200 is depicted in FIG. 2 as a hand held device, such as a PDA, cellular telephone, or other similar device. It will be appreciated that in alternate embodiments, the schedule-keeping device 200 may be implemented in any desired type of component or system, including, for example, in a laptop or tablet computer, wrist watch, media drive, alarm clock or any other suitable component. Such schedule-keeping devices 200 may also be integrated into any other types of articles that may accompany the traveler, such as a purse, clothing, luggage, or any other suitable article.

FIG. 3 is a flowchart of a method 300 of schedule keeping in accordance with another embodiment of the present disclosure. The method 300 is illustrated as a collection of blocks in a logical flow graph, which represents a sequence of operations (e.g. that may be performed by the schedule-keeping component 220) that can be implemented in hardware, software, or a combination thereof. In the context of software, the blocks represent computer instructions that, when executed by one or more processors, perform the recited operations. For purposes of discussion, the method 300 is described with reference to the components of the exemplary environment 100 and the exemplary device 200 described above with reference to FIGS. 1 and 2.

In this embodiment, the method 300 includes setting milestones for the traveler's journey at 302. As used herein, the term “fixed milestone” is a time that, although a schedule of the traveler may change, remains fixed and which may be critical to the traveler's journey. In the example shown in FIG. 1, a start time for the journey may be established as a first fixed milestone (e.g. after a final meeting at the office 102), and a second fixed milestone may be an aircraft departure time from SeaTac airport 108. A third fixed milestone may be, for example, a start time of a meeting the traveler desires to attend in Denver.

The method 300 receives system standards at 304, and one or more maps or other travel-related information at 306. Using this information, the method 308 begins developing a travel plan by making reservations on one or more suitable transportation systems at 308. As reservations are confirmed (at 308), a critical path (or travel plan) is established at 310.

It will be appreciated that alternate embodiments of the present disclosure may combine various pieces of information at 304, 306 to create the travel plan. Examples of pieces of information that could be relevant in this situation include, but are not limited to: stored personal information (home/work address, type of car driven, access to public transportation, preferences); city road maps; traffic conditions; public transportation schedules; weather conditions; parking availability; ticket queue length; security queue length; walking distance requirements; airline delay information; airport congestion information; and amenity availability and location.

Some or all of the information described above may be used to determine approximately how long it will take for an individual or group get from one location to another. Additional information such as personal preferences (e.g. likes to walk, wants to avoid lines, likes to be early, average driving speeds) and current states of being (hungry, nervous, in an unfamiliar location) can also be taken into account to provide enhancement to the journey that is being modeled. If multiple events are happening concurrently, the method 300 may determine which of these lie on the critical path and may use this to judge the total length of time necessary for the entire series of events to take place. Set milestones will be noted within the system (e.g. bus departure, plane departure, meeting start time) and the notifications will be gauged to notify the traveler when these milestones will not be able to be met under the current conditions. The method 300 may then pull from all available resources to attempt to find alternate solutions that will still allow the milestones to be met and may inform the traveler of these possibilities.

As further shown in FIG. 3, at any time after the travel plan is established (at 310), the method 300 may receive travel-related inputs at 312 from one or more of the plurality of information sources 252. For example, the travel-related inputs at 312 may include traffic reports, parking availability, airline delays, weather conditions (particularly those that may impact travel), queue lengths, congestion details, or any other relevant information, including any or all of the travel plan information described above with reference to the information provided 304, 306. The inputs may be analyzed (or checked) at 314, and relevant information may be output to the traveler at 316. For example, the method 300 may inform the traveler via a visual display (e.g. I/O device 204 of the schedule-keeping device 200) that the traveler is on schedule, behind schedule, or ahead of schedule. Alternately, any other information resulting from the inputs 312 and the analyses 314 may be provided to the traveler if more detail is preferred.

As further shown in FIG. 3, a determination is made whether the traveler's travel plan will be impacted (adversely or favorably) by the inputs at 318. If the inputs (at 312) do not require a digression or revision of the travel plan, then the method 300 returns to 312 and repeats the receiving of the inputs (at 312), analyzing the inputs (at 314), providing information to the traveler (at 316), and determining whether digressions from the travel plan are needed (at 318) indefinitely throughout the traveler's journey.

If a digression (or revision) of the traveler's travel plan is determined to be necessary at 318, the method 300 may then return to 308 and may repeat one or more of the activities described in 308-316 based on the inputs 312. More specifically, in some embodiments, if an input at 312 (e.g. a weather or traffic incident) extends the critical path of the journey, the method 300 may automatically conduct analyses of one or more alternatives (at 310) in an attempt to find a remedial course of action (e.g. find an alternate path or suggest an earlier start time). If the method 300 is unable to determine possible remedial courses of action, the method 300 may perform analyses to determine when the traveler would be able to arrive at the airport 108, and may determine (at 308) and recommend a new flight that would not interfere with the final goal of attending the meeting in Denver on time.

For example, in the embodiment shown in FIG. 1, a particular set of weather and traffic condition inputs may be received at 312 relating to the traveler's intended driving path along the first highway 104. At 314, the weather and traffic condition inputs may be analyzed to determine a drive time along the first highway 104 from the office 102 in Everett, Wash. to Seatac Airport 108. If it is determined at 316 that the weather and traffic condition inputs would cause an impermissible delay between the first milestone (the traveler's departure time from the office 102) and the second milestone (the departure time of the commercial aircraft 122), then the method 300 may re-analyze or update the travel plan (at 310) and recommend to the traveler an alternate driving route, such as along a second highway 105 (e.g. I-405) which the inputs suggest would allow the traveler to remain on schedule. Alternately, the method 300 may determine that no alternate driving routes are available that satisfy the milestones, and may re-analyze the reservation information of available commercial airline flights at 308, and may recommend an update to the traveler to revise the travel plan by moving the second milestone to a departure on another commercial airline that will still allow the traveler to reach the meeting in Denver on time with an available seat to accommodate the system inputs (at 312).

Similarly, if the traveler preferred to use public transportation from the office 102 to the airport 108, the method 300 could receive the bus and rail schedules as inputs (at 306), and may receive or determine average or estimated walk times in between the various destinations and forms of transportation used based on an average or estimated walking speed of the traveler. The weather or traffic information received as inputs (at 312) may be analyzed at 314, and digressions or revisions determined at 318 as described above.

At or near the airport 108, or at any other suitable point in the journey, the method 300 may use one or more inputs at 312 (e.g. queue length information) to determine how long it will take the traveler to reach the necessary gate for the departing commercial airplane 122. If sufficient time is available, the traveler would know that there is time to stop somewhere along this journey for a desired break or action (e.g. to eat a meal, make telephone calls, check email, etc.). Alternately, if the method 300 determined based on the inputs 312 that there was little or no time to space, the traveler would know to move at a heightened pace, or take other action needed to remain on schedule (e.g. pay more for a more convenient parking space, skip a meal, etc.).

Embodiments of systems and methods in accordance with the present disclosure may provide considerable advantages over the prior art. For example, embodiments of the present disclosure may assist a traveler in keeping with an established or desired travel schedule. Such embodiments may seamlessly improve the travel process, and may be used for all types of travel, such as walking, bus or subway travel, flight, and taxi. By taking into consideration a number of factors that could influence the time required to get from one place to another and arrive on time (e.g. provided by information sources 252), embodiments in accordance with the present disclosure may make the travel process, and all of the sub-processes involved in the travel process, easier for the traveler to navigate.

In conventional travel, there are typically many complex systems in place that are individually easy to use but which are not integrated into a single, useful system for the traveler to access when necessary. Thus, the traveler participating in conventional travel is required to manually access many different data systems in order to obtain reliable information. These conventional processes may be undesirably tedious, and may fail to provide any overarching benefit to streamlining the travel process. Embodiments of methods and systems in accordance with the present disclosure seek to mitigate the inconvenience of the conventional systems by bringing together all of the information necessary to provide accurate and up-to-date flow time and speed through the entire travel journey. Such embodiments may also seek to clearly convey to the traveler if they are ahead of schedule, behind schedule, or on schedule without overwhelming the traveler with information. The detailed information is available if it is of interest to the individual traveler.

As described above, embodiments of systems and methods in accordance with the present disclosure may therefore provide the following aspects: accounting for personal preferences of the traveler; ability to pull real-time information from various sources; integrating these pieces of information into a timeline; determination of the critical path through this timeline; keeping the traveler up to date of current status in their journey; rescheduling necessary milestones without input of traveler; and logic to take appropriate action to allow traveler to keep necessary milestones.

While specific embodiments of the invention have been illustrated and described herein, as noted above, many changes can be made without departing from the spirit and scope of the invention. Accordingly, the scope of the invention should not be limited by the disclosure of the specific embodiments set forth above. Instead, the invention should be determined entirely by reference to the claims that follow.

What is claimed is:

1. A method of providing a travel schedule for a traveler, comprising:
providing one or more travel milestones;
providing travel plan information;
formulating a travel plan based on the one or more travel milestones and the travel plan information;
receiving one or more travel-related inputs;
analyzing the one or more travel-related inputs to determine a travel status based on the one or more travel-related inputs and the travel plan; and
outputting the travel status to the traveler.

2. The method of claim 1, wherein providing travel plan information includes providing at least one of: stored personal information regarding the traveler, a road map, a traffic condition, a public transportation schedule, a weather condition, a parking availability, a queue length, a walking distance, an airline status information, an airport congestion information, and an amenity-related information.

3. The method of claim 1, wherein providing travel plan information includes providing traveler-specific information including at least one of a likes-to-walk preference, a wants-to-avoid lines preference, a likes-to-be-early preference, and a current state of being information.

4. The method of claim 1, wherein receiving one or more travel related inputs includes receiving at least one of: a traffic report, a parking availability, an airline schedule information, a weather condition, a queue length, and a congestion detail.

5. The method of claim 1, wherein receiving one or more travel related inputs includes receiving traveler-specific state of being information including at least one of a hunger condition, a nervousness condition, and a familiarity condition.

6. The method of claim 1, wherein outputting the travel status to the traveler includes outputting an on-schedule status, an ahead-of-schedule status, or a behind-schedule status.

7. The method of claim 1, further comprising:
if the travel status comprises a behind-schedule status, formulating a revised travel plan based on the travel-related inputs and at least one of the travel plan information and the travel milestones; and
outputting to the traveler a proposed remedial action in accordance with the revised travel plan.

8. The method of claim 7, wherein the proposed remedial action includes at least one of a revised route, a revised transportation system reservation, and a revised transportation system type.

9. The method of claim 1, further comprising:
if the travel status comprises a behind-schedule status, attempting to formulate a revised travel plan based on the travel-related inputs and at least one of the travel plan information and the travel milestones;
if attempting to formulate a revised travel plan is unsuccessful, identifying at least one of a revised travel milestone and a revised travel plan information; and
outputting to the traveler the at least one of the revised travel milestone an the revised travel plan information.

10. A method of providing a travel schedule for a traveler, comprising:
providing a plurality of travel milestones and travel plan information;
formulating a travel plan based on the plurality of travel milestones and travel plan information;
receiving a plurality of travel-related inputs;
analyzing the plurality of travel-related inputs to determine a travel status based on the plurality of travel-related inputs and the travel plan;
if the travel status comprises a behind-schedule status, formulating a revised travel plan based on the plurality of travel-related inputs and the plurality of travel milestones and travel plan information; and
outputting to the traveler a proposed remedial action in accordance with the revised travel plan.

11. The method of claim 10, wherein providing a plurality of travel milestones and travel plan information includes providing traveler-specific information including at least one of a likes-to-walk preference, a wants-to-avoid lines preference, a likes-to-be-early preference, and a current state of being information.

12. The method of claim 10, wherein receiving a plurality of travel-related inputs includes receiving traveler-specific state of being information including at least one of a hunger condition, a nervousness condition, and a familiarity condition.

13. The method of claim 10, further comprising outputting the travel status to the traveler.

14. The method of claim 10, wherein the proposed remedial action includes at least one of a revised route, a revised transportation system reservation, and a revised transportation system type.

15. A schedule-keeping device, comprising:
a processor;
at least one input/output component coupled to the processor and configured to communicate with one or more sources of information via a network, and to provide output to the traveler;
a memory operatively coupled to the processor and to the at least one input/output component, the memory being configured to store instructions that, when executed by the processor, perform a method including:
receiving a plurality of travel milestones and travel plan information;
providing travel plan information;
formulating a travel plan based on the one or more travel milestones and the travel plan information;
receiving one or more travel-related inputs;
analyzing the one or more travel-related inputs to determine a travel status based on the one or more travel-related inputs and the travel plan; and
outputting the travel status to the traveler.

16. The system of claim 15, wherein the instructions are further configured such that receiving a plurality of travel milestones and travel plan information includes receiving at least one of: stored personal information regarding the traveler, a road map, a traffic condition, a public transportation schedule, a weather condition, a parking availability, a queue length, a walking distance, an airline status information, an airport congestion information, and an amenity-related information.

17. The system of claim 15, wherein the instructions are further configured such that receiving one or more travel-related inputs includes receiving at least one of: a traffic report, a parking availability, an airline schedule information, a weather condition, a queue length, and a congestion detail.

18. The system of claim 15, wherein the instructions are further configured such that outputing the travel status to the traveler includes outputting an on-schedule status, an ahead-of-schedule status, or a behind-schedule status.

19. The system of claim 15, wherein the instructions are further configured such that the method further includes:
if the travel status includes a behind-schedule status, formulating a revised travel plan based on the travel-related inputs and at least one of the travel plan information and the travel milestones; and
outputting to the traveler a proposed remedial action in accordance with the revised travel plan.

20. The system of claim 15, wherein the instructions are further configured such that the method further includes:
if the travel status comprises a behind-schedule status, attempting to formulate a revised travel plan based on the travel-related inputs and at least one of the travel plan information and the travel milestones;
if attempting to formulate a revised travel plan is unsuccessful, identifying at least one of a revised travel milestone and a revised travel plan information; and
outputting to the traveler the at least one of the revised travel milestone an the revised travel plan information.
